(19) United States
(12) Patent Application Publication
(10) Pub. No.: US 2011/0139556 A1
(43) Pub. Date: Jun. 16, 2011

(54) FOOT BRAKE FOR PROPULSION VEHICLES

(76) Inventors: Mark M. Kiviahde, Bellemont, AZ (US); Harold D. Johnson, Zimmerman, MN (US)

(21) Appl. No.: 12/808,770

(22) PCT Filed: Dec. 16, 2008
(86) PCT No.: PCT/US08/86943

§ 371 Date: Jun. 17, 2010

Related U.S. Application Data
(60) Provisional application No. 61/015,546, filed on Dec. 20, 2007.

(51) Int. Cl. F16D 49/00

(52) U.S. Cl. 188/74

(57) ABSTRACT

A foot-operated parking brake eliminates the need for hand disengagement. A J-bar element 14 pivots to engage pegs 20 against the tires 22 of the propulsion unit 10. The J-bar 14 has a pivotable pedal assembly 24 mounted thereon which may releasably engage a latch plate 30 mounted on the frame 12. The operator may release the brake by pressing the lower portion of the pedal 26 with his or her heel.

### TECHNICAL FIELD

This application claims the benefit of U.S. application Ser. No. 61/015,546, filed Dec. 20, 2007, the contents of which are hereby incorporated by reference.

### BACKGROUND ART

Line striper propulsion units are well known such as those sold under the LINEDRIVER trademark by the assignee of the instant invention. In such units, a gasoline engine directly drives a hydraulic pump that supplies a hydrostatic drive system. When operated on inclines and for transport, the ability to have a parking brake function is helpful.

### DISCLOSURE OF THE INVENTION

A foot-operated parking brake eliminates the need for hand disengagement of the prior art design. A J-bar pivots to engage pegs against the tires of the propulsion unit. The J-bar has a pivotable pedal unit mounted thereon which may releasably engage a latch plate mounted on the frame. The operator may release the brake by pressing the lower portion of the pedal with his or her heel.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the pedal mechanism of the instant invention mounted on a propulsion unit.

FIG. 2 shows the return spring detail on the pedal.

FIG. 3 shows the brake disengaged.

FIG. 4 shows the brake engaged.

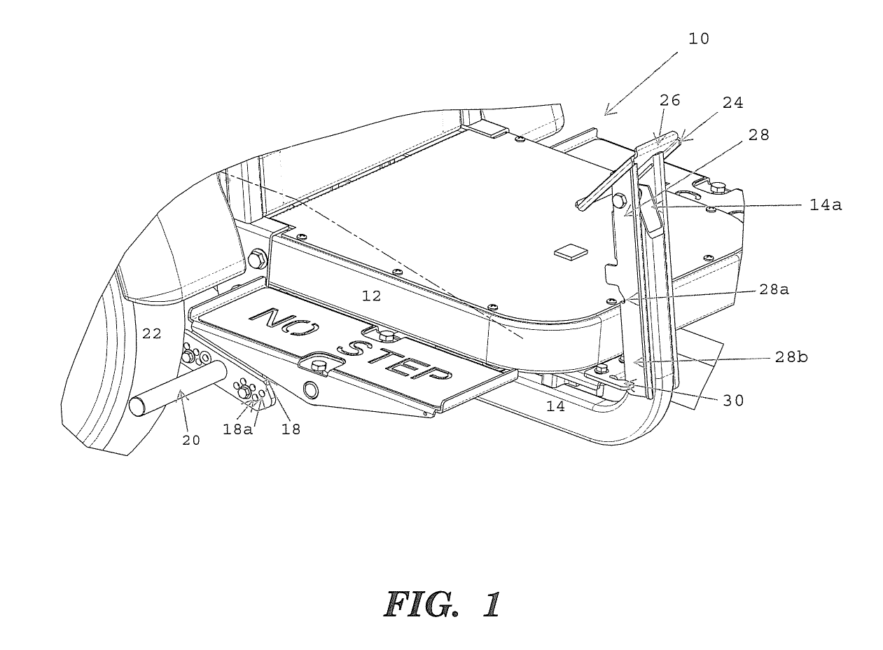

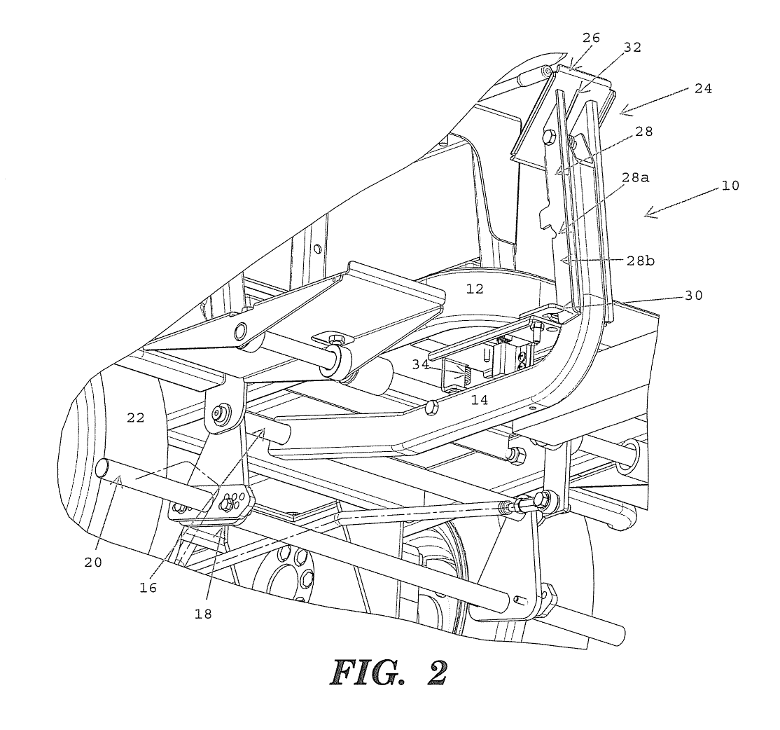

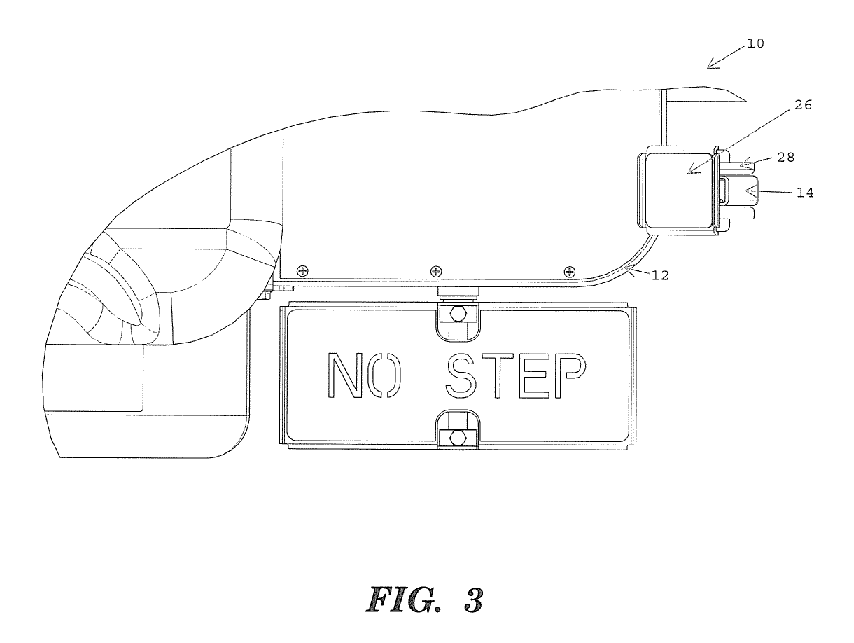

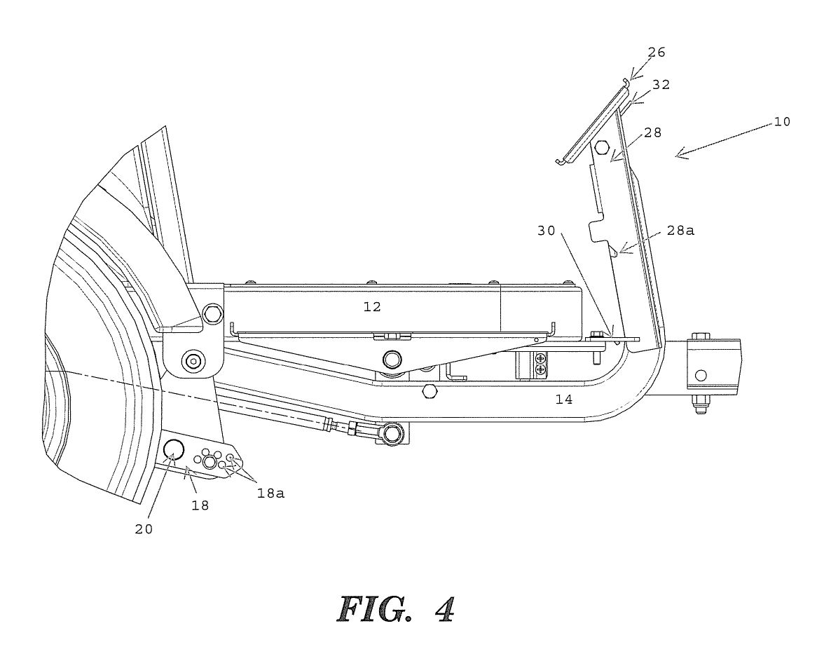

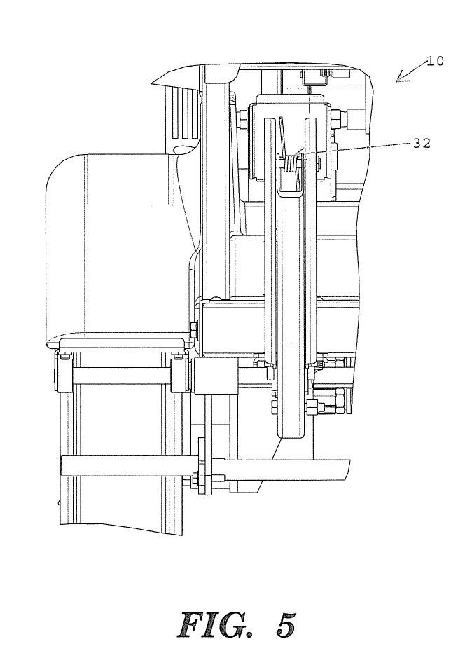

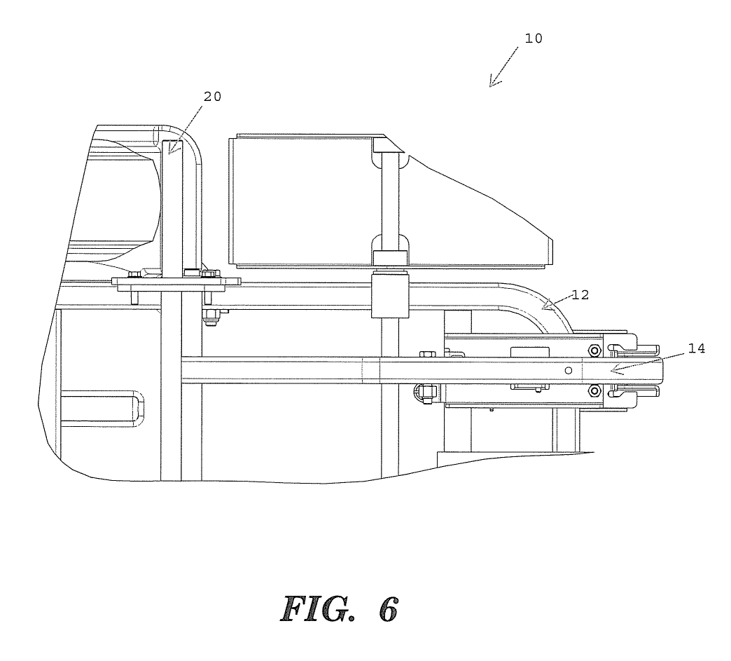

### BEST MODE FOR CARRYING OUT THE INVENTION

A propulsion unit, such as would be used to propel a line striper (or push mower or most any other walk-behind implement), is generally designated 10. A J-bar weldment element 14 is pivotably attached to frame 12 via shaft 16. A peg bracket 18 is attached to shaft 16 and has adjustably mounted thereto via a plurality of holes 18a first and second pegs 20 which are located so as to frictionally engage tires 22 when the brake is engaged. The adjustability provided by holes 18a allows for compensation for wear of the tires 22 and pegs 20.

A pedal assembly 24 is comprised of a pedal 26 welded or otherwise attached to the top of pedal latch member 28. Pedal latch member 28 is pivotably mounted to the top end 14a of J-bar 14 and has a notch 28a located adjacent latch plate 30 which is attached to frame 12. A pedal spring 32 is mounted at the pivot point of pedal assembly 24 so as to bias the lower end 28b of pedal latch member 28 toward latch plate 30. A return spring 34 serves to bias the J-bar 14 so that pegs 20 are not engaged.

In operation, the operator need merely press on pedal 26 until pegs 20 press against tires 22. When foot pressure is released, notch 28a engages latch plate 30 locking the brake in place. When it is desired to release the brake, the operator need merely press the lower portion of the pedal causing the lower end 28b of pedal latch member 28 to move away from engagement with the latch plate 30.

It is contemplated that various changes and modifications may be made to the propulsion unit without departing from the spirit and scope of the invention as defined by the following claims.

1. In a propulsion unit having a frame and a parking brake element engaging tires of the unit, the improvement comprising:
a latch plate on said frame; and
a pedal assembly pivotably mounted to said brake element and pivotable between first and second positions whereby in said first position said pedal assembly engages said latch plate to engage said tires and whereby in said second position and pedal assembly is disengaged from said latch plate.

2. The propulsion unit of claim 1 wherein said pedal assembly is biased toward said first position.

3. The propulsion unit of claim 1 further comprising pegs for engaging said tires and a plurality of holes for adjustably positioning said pegs relative to said tires and said brake element.
